(19) United States
(12) Patent Application Publication
(10) Pub. No.: US 2012/0158742 A1
(43) Pub. Date: Jun. 21, 2012

(54) MANAGING DOCUMENTS USING WEIGHTED PREVALENCE DATA FOR STATEMENTS

(75) Inventors: Frederick A. Kulack, Rochester, MN (US); Kevin G. Paterson, San Antonio, TX (US); John E. Petri, St. Charles, MN (US)

(73) Assignee: INTERNATIONAL BUSINESS MACHINES CORPORATION, Armonk, NY (US)

(21) Appl. No.: 12/971,769

(22) Filed: Dec. 17, 2010

(51) Int. Cl. G06F 7/00; G06F 17/30

(52) U.S. Cl. 707/748; 707/E17.093

(57) ABSTRACT

In an embodiment, respective strengths are determined for respective relationships in respective statements. Weights are decreased for the respective statements in proportion to respective amounts of time since the respective statements were added to documents. The weights are increased for a subset of the statements that were modified in a subset of the documents. Weighted prevalence data is calculated for respective time periods for the respective statements to be a sum of the weights for the respective statements in the time periods for those statements that have the respective strengths.

### FIELD

An embodiment of the invention generally relates to computer systems and more particularly to computer systems that perform semantic processing of statements in documents.

### BACKGROUND

Computer systems typically comprise a combination of computer programs and hardware, such as semiconductors, transistors, chips, circuit boards, storage devices, and processors. The computer programs are stored in the storage devices and are executed by the processors. Fundamentally, computer systems are used for the storage, manipulation, and analysis of data.

Two different types of data are structured data and unstructured data. Structured data has a data model, data schema, or data structure that describes the format of the data and helps to give meaning to the data. An example of structured data is a database with records and fields, such as a record with a name field, an address field, and a telephone number field. The fields describe the organization of the records and help to give meaning to the data stored in the records. Unstructured data does not have a data model or has a data model that is not easily used. Examples of unstructured data include documents, such as word processing documents, emails, articles, or files that contain text, prose, or audio speech that can be converted to text. Special tools exist that find patterns in, interpret, assign meaning to, or give structure to the unstructured data. One such tool is the Unstructured Information Management Architecture (UIMA) framework available from INTERNATIONAL BUSINESS MACHINES CORPORATION, which provides a common framework for processing unstructured information to extract meaning and create structured data from the unstructured information.

### SUMMARY

A method, computer-readable storage medium, and computer system are provided. In an embodiment, respective strengths are determined for respective relationships in respective statements. Weights are decreased for the respective statements in proportion to respective amounts of time since the respective statements were added to documents. The weights are increased for a subset of the statements that were modified in a subset of the documents. Weighted prevalence data is calculated for respective time periods for the respective statements to be a sum of the weights for the respective statements in the time periods for those statements that have the respective strengths.

### BRIEF DESCRIPTION OF THE SEVERAL VIEWS OF THE DRAWINGS

FIG. 1 depicts a high-level block diagram of an example system for implementing an embodiment of the invention.

FIG. 2 depicts a block diagram of a user I/O device displaying a prevalence graph, according to an embodiment of the invention.

FIG. 3 depicts a block diagram of an example data structure for topic data, according to an embodiment of the invention.

FIG. 4 depicts a block diagram of an example data structure for weight data, according to an embodiment of the invention.

FIG. 5 depicts a block diagram of an example data structure for prevalence data, according to an embodiment of the invention.

FIG. 6 depicts a flowchart of example processing for creating topic data, according to an embodiment of the invention.

FIG. 7 depicts a flowchart of example processing for updating weight data and topic data, according to an embodiment of the invention.

FIG. 8 depicts a flowchart of example processing for creating prevalence data, according to an embodiment of the invention.

It is to be noted, however, that the appended drawings illustrate only example embodiments of the invention, and are therefore not considered a limitation of the scope of other embodiments of the invention.

### DETAILED DESCRIPTION

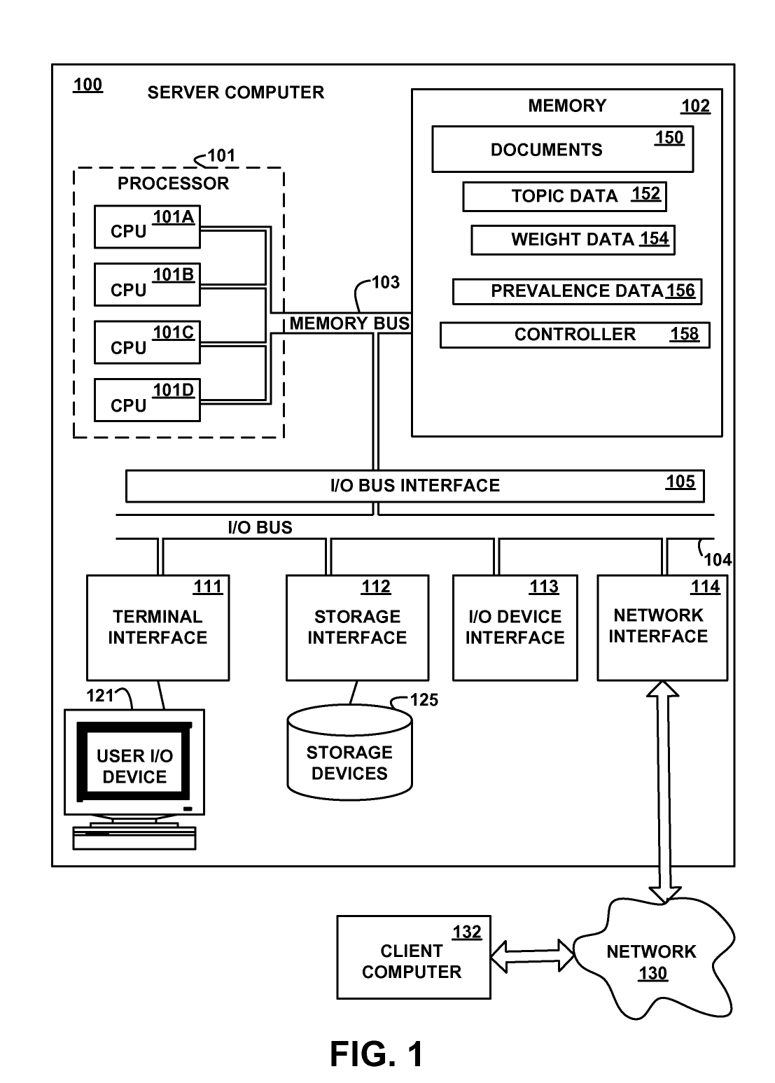

Referring to the Drawings, wherein like numbers denote like parts throughout the several views, FIG. 1 depicts a high-level block diagram representation of a server computer system 100 connected to a client computer system 132 via a network 130, according to an embodiment of the present invention. The term “server” is used herein for convenience only, and in various embodiments a computer system that operates as a client computer in one environment may operate as a server computer in another environment, and vice versa. The mechanisms and apparatus of embodiments of the present invention apply equally to any appropriate computing system.

The major components of the computer system 100 comprise one or more processors 101, a main memory 102, a terminal interface 111, a storage interface 112, an I/O (Input/Output) device interface 113, and a network adapter 114, all of which are communicatively coupled, directly or indirectly, for inter-component communication via a memory bus 103, an I/O bus 104, and an I/O bus interface unit 105. The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may comprise one or more levels of on-board cache.

In an embodiment, the main memory 102 may comprise a random-access semiconductor memory, storage device, or storage medium for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes documents 150, topic data 152, weight data 154, prevalence data 156, and a controller 158. Although the documents 150, topic data 152, weight data 154, prevalence data 156, and the controller 158 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the documents 150, the topic data 152, the weight data 154, the prevalence data 156, and the controller 158 are illustrated as being contained within the main memory 102, these elements are not necessarily all completely contained in the same storage device at the same time. Further, although the documents 150, the topic data 152, the weight data 154, the prevalence data 156, and the controller 158 are illustrated as being separate entities, in other embodiments some of them, portions of some of them, or all of them may be packaged together.

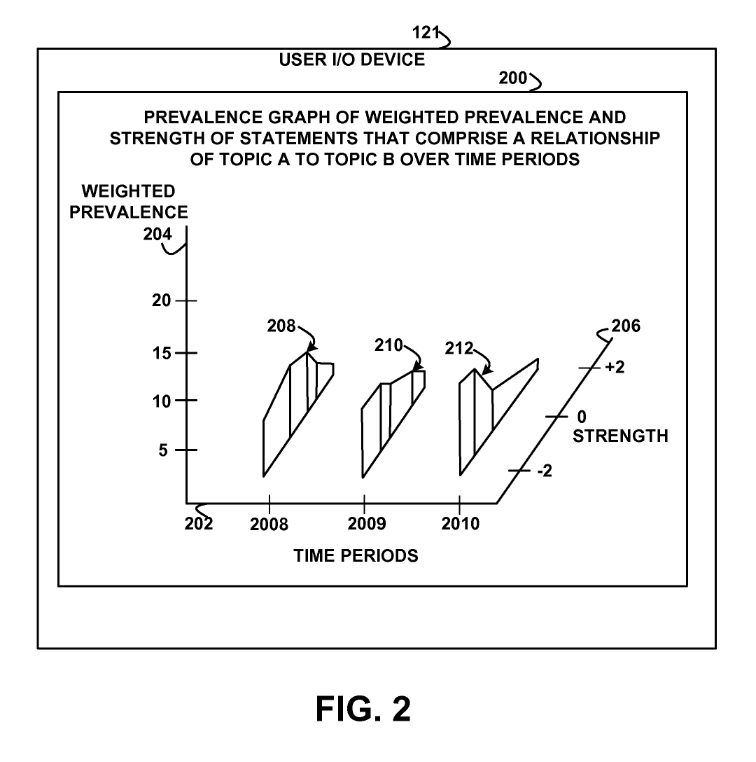

In an embodiment, the controller 158 comprises instructions or statements that execute on the processor 101 or instructions or statements that are interpreted by instructions or statements that execute on the processor 101, to carry out the functions as further described below with reference to FIGS. 2, 3, 4, 5, 6, 7, and 8. In another embodiment, the controller 158 is implemented in hardware via semiconductor devices, chips, logical gates, circuits, circuit cards, and/or other physical hardware devices in lieu of, or in addition to, a processor-based system. In an embodiment, the controller 158 comprises data in addition to instructions or statements. In various embodiments, the controller 158 is a user application, a third-party application, an operating system, or any portion, multiple, or combination thereof.

In an embodiment, the controller 158 comprises a text analysis engine. The text analysis engine parses the documents 150 to identify unique concepts, grammatical parts of speech, proper names, etc., as well as to identify related concepts in the documents 150 that tend to indicate contextual relationships between those concepts. Different text analysis tools may be used that are tailored to specific knowledge areas, such as medical, financial, etc. The text analysis engine may used natural language searching, fuzzy searching, and data mining techniques to perform semantic analysis of the documents 150.

The documents 150 comprise one or more documents of text characters that make up words, phrases, sentences, sentence fragments, punctuation, or any portion, multiple, or combination thereof. The documents 150 may also comprise audio, video, or graphics. In various embodiments, the documents 150 may comprise a combination of structured and unstructured information. For example, the unstructured information may be packaged into objects (e.g., files and documents) that have some structure, and the documents may comprise formatting or markup tags in addition to unstructured text.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The I/O interface units support communication with a variety of storage and I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer system 100, and may receive output data via the user output devices. For example, a user interface may be presented via the user I/O device 121, such as displayed on a display device, played via a speaker, or printed via a printer.

The storage interface unit 112 supports the attachment of one or more disk drives or secondary storage devices 125. In an embodiment, the secondary storage devices 125 are rotating magnetic disk drive storage devices, but in other embodiments they are arrays of disk drives configured to appear as a single large storage device to a host computer, or any other type of storage device. The contents of the main memory 102, or any portion thereof, may be stored to and retrieved from the secondary storage devices 125, as needed. In an embodiment, the secondary storage devices 125 store more data and have a slower access time than does the memory 102, meaning that the time needed to read and/or write data from/to the memory 102 is less than the time needed to read and/or write data from/to for the secondary storage devices 125.

The I/O device interface 113 provides an interface to any of various other input/output devices or devices of other types, such as printers or fax machines. The network adapter 114 provides one or more communications paths from the computer system 100 to other digital devices and computer systems 132; such paths may comprise, e.g., one or more networks 130. Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 is implemented as a desktop computer, portable computer, laptop or notebook computer, tablet computer, pocket computer, telephone, smart phone, pager, automobile, teleconferencing system, appliance, or any other appropriate type of electronic device.

The network 130 may be any suitable network or combination of networks and may support any appropriate protocol suitable for communication of data and/or code to/from the computer system 100 and the computer system 132. In various embodiments, the network 130 may represent a storage device or a combination of storage devices, either connected directly or indirectly to the computer system 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

In an embodiment, the client computer 132 may comprise some or all of the elements of the server computer 100.

FIG. 1 is intended to depict the representative major components of the computer system 100 and the network 130. But, individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program components illustrated in FIG. 1 and implementing various embodiments of the invention may be implemented in a number of manners, including using various computer applications, routines, components, programs, objects, modules, data structures, etc., and are referred to hereinafter as “computer programs,” or simply “programs.”

The computer programs comprise one or more instructions or statements that are resident at various times in various memory and storage devices in the computer system 100 and that, when read and executed by one or more processors in the computer system 100 or when interpreted by instructions that are executed by one or more processors, cause the computer system 100 to perform the actions necessary to execute steps or elements comprising the various aspects of embodiments of the invention. Aspects of embodiments of the invention may be embodied as a system, method, or computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk (e.g., the secondary storage devices 125), a random access memory (RAM) (e.g., the memory 102), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, radio frequency, or any suitable combination of the foregoing.

Computer program code for carrying out operations for aspects of embodiments of the present invention may be written in any combination of one or more programming languages, including object oriented programming languages and conventional procedural programming languages. The program code may execute entirely on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments of the invention are described below with reference to flowchart illustrations and/or block diagrams of methods, apparatus (systems), and computer program products. Each block of the flowchart illustrations and/or block diagrams, and combinations of blocks in the flowchart illustrations and/or block diagrams may be implemented by computer program instructions embodied in a computer-readable medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified by the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture, including instructions that implement the function/act specified by the flowchart and/or block diagram block or blocks.

The computer programs defining the functions of various embodiments of the invention may be delivered to a computer system via a variety of tangible computer-readable storage media that may be operatively or communicatively connected (directly or indirectly) to the processor or processors. The computer program instructions may also be loaded onto a computer, other programmable data processing apparatus, or other devices to cause a series of operational steps to be performed on the computer, other programmable apparatus, or other devices to produce a computer-implemented process, such that the instructions, which execute on the computer or other programmable apparatus, provide processes for implementing the functions/acts specified in the flowcharts and/or block diagram block or blocks.

The flowchart and the block diagrams in the figures illustrate the architecture, functionality, and operation of possible implementations of systems, methods, and computer program products, according to various embodiments of the present invention. In this regard, each block in the flowcharts or block diagrams may represent a module, segment, or portion of code, which comprises one or more executable instructions for implementing the specified logical function(s). In some embodiments, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flow chart illustrations, can be implemented by special purpose hardware-based systems that perform the specified functions or acts, in combinations of special purpose hardware and computer instructions.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments illustrated in FIG. 1 are not intended to limit the present invention. Indeed, other alternative hardware and/or program environments may be used without departing from the scope of embodiments of the invention.

FIG. 2 depicts a block diagram of a user I/O device 121 displaying a prevalence graph 200, according to an embodiment of the invention. The prevalence graph 200 is illustrated using a two-dimensional depiction of a three-dimensional coordinate system, with weighted prevalence data on the y-axis (vertical axis) 204, a strength of statements on the z-axis 206, and time periods illustrated on the x-axis (horizontal axis) 202. Each point on the lines 208, 210, and 212 thus represents a statement (that comprises a topic A and a topic B) via three numerical coordinate values: a weighed prevalence data value of a strength value during a particular time period. The weighted prevalence data is the (weighted) number of the statements (that exist in the documents 150) that comprise a relationship of the topic A to the topic B. The strength characterizes the strength or conviction of the opinion of the author of the relationship that is stated in the statement. The time period is the period of time during which the strength and (weighted) prevalence exists in the documents 150. In an embodiment, the prevalence graph 200 illustrates a comparison of the relationships of statements over time, depicting, e.g., which statement strengths were outliers or were rare (least prevalent) and which statement strengths were more common or represent the predominant view (most prevalent) of statements made in the domain of the documents 150. The example prevalence graph 200 illustrates that statements with topics A and topics B comprise relationships that had strengths that were predominantly neutral (with the strengths of approximately zero having the highest weighted prevalence) in 2008, but which have become more negative over time.

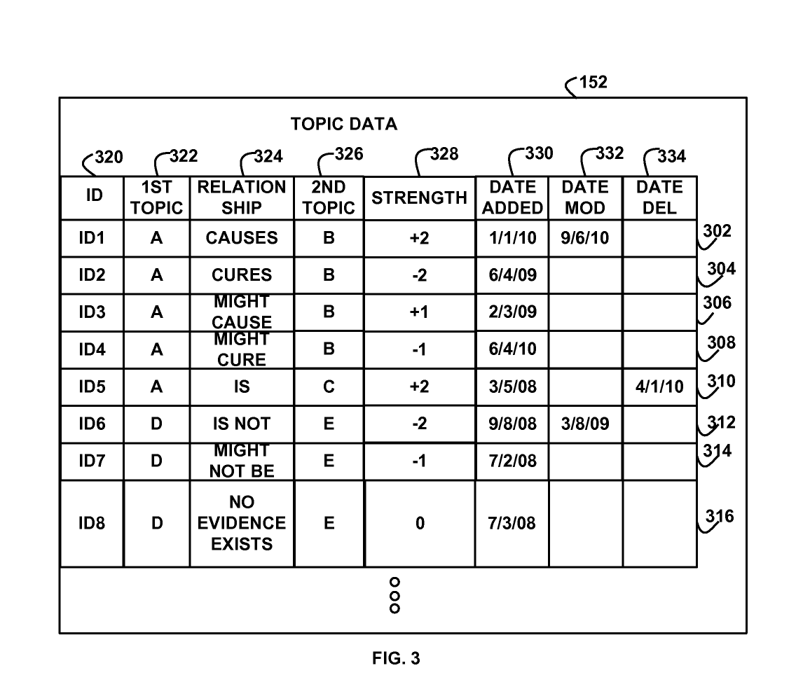

FIG. 3 depicts a block diagram of an example data structure for topic data 152, according to an embodiment of the invention. The topic data 152 comprises example records 302, 304, 306, 308, 310, 312, 314, and 316, each comprising an example identifier field 320, an example first topic field 322, an example relationship field 324, an example second topic field 326, an example strength field 328, an example date added field 330, an example date modified field 332, and an example date deleted field 334.

The identifier field 320 may uniquely identify a statement in a document 150. The identifier 320 may uniquely identify the statement by identifying a line, statement, or sentence number within a document 150, by identifying the document 150 that comprises the statement, by identifying a directory or subdirectory in which the document 150 is stored, by identifying a network address at which the document 150 is stored, or any combination thereof. The statement is a sentence or a sentence fragment in a document 150 and comprises the first topic 322, the relationship 324, and the second topic 326. The first topic 322 and the second topic 326 comprise nouns or phrases that contain nouns in the document 150 that is identified by the identifier 320 in the same record. In various embodiments, the same or different authors may create, modify, or delete the same or different statements in the documents 150.

The relationship 324 may be a verb or a verb phrase and identifies a relationship, category, or connection between the first topic 322 and the second topic 326, in the same record. Examples of relationships include “is,” “is not,” “has,” “does not have,” “causes,” “does not cause,” “cures,” “does not cure”, and “no evidence exists.” In various embodiments, the relationship 324 may identify a causal relationship, a hierarchical relationship, a connective relationship, a concomitant relationship, a quantitative relationship, a qualitative relationship, or any other type or relationship.

In an embodiment the strength 328 is a value, such as a numerical value, that identifies, characterizes, or describes the strength, significance, intensity, or importance of the relationship 324 in the same record. The strength 328 describes the relationship 324 that is stated by the author of the statement and characterizes the amount or degree of conviction of the opinion of the author, as to the relationship 324 between the first topic 322 and the second topic 326. For example, the strength 328 in the record 302 is a larger (higher positive) number than the strength 328 in the record 306 because the relationship 324 of “causes” in the record 302 has a higher degree of author conviction or certainty than the relationship 324 of “might cause” in the record 306. Analogously, the strength 328 in the record 312 is a lower (higher absolute value) number than the strength 328 in the record 314 because the relationship 324 of “is not” in the record 312 has a higher degree of author conviction or certainty than the relationship 324 of “might not be” in the record 314. The strength 328 in the record 316 is zero because the author of the statement indicates a neutral relationship between the first topic 322 and the second topic 326 in the same record via the relationship “no evidence exists.”. Other examples of neutral relationships include “no conclusion can be drawn,” and “the evidence is insufficient to support a determination.”

In an embodiment, the strength 328 may be positive, negative, or neutral. Positive and negative strengths identify opposite relationships, and a neutral strength is between the positive and the negative strengths. If a first statement with a high positive strength between two topics is true, then a second statement with a high negative (a negative sign with a high absolute value) strength (an opposite strength) between those two topics is false. If a first statement with a high positive strength between two topics is false, then a second statement with a high negative (a negative sign with a high absolute value) strength (an opposite strength) between those two topics is true. If a first statement with a high negative (a negative sign with a high absolute value) strength between two topics is true, then a second statement with a high positive strength (an opposite strength) between those two topics is false. If a first statement with a high negative (a negative sign with a high absolute value) strength between two topics is false, then a second statement with a high positive strength (an opposite strength) between those two topics is true. A strength is highly positive if it is more than a threshold number and highly negative if it is less than another threshold number. In other embodiments, any range of numbers for the strength 328 may be used.

The date added field 330 specifies the date that the statement in the same record was added to a document 150. The date modified field 332 specifies the date that the statement in the same record was modified, updated, or changed in the document 150, subsequent to being added to the document 150. The date deleted field 334 specifies the date that the statement in the same record was deleted or removed from the document 150. In various embodiments, the dates may comprise centuries, decades, years, months, days, days of the week, hours, minutes, seconds, or any multiple, portion, and/or combination thereof.

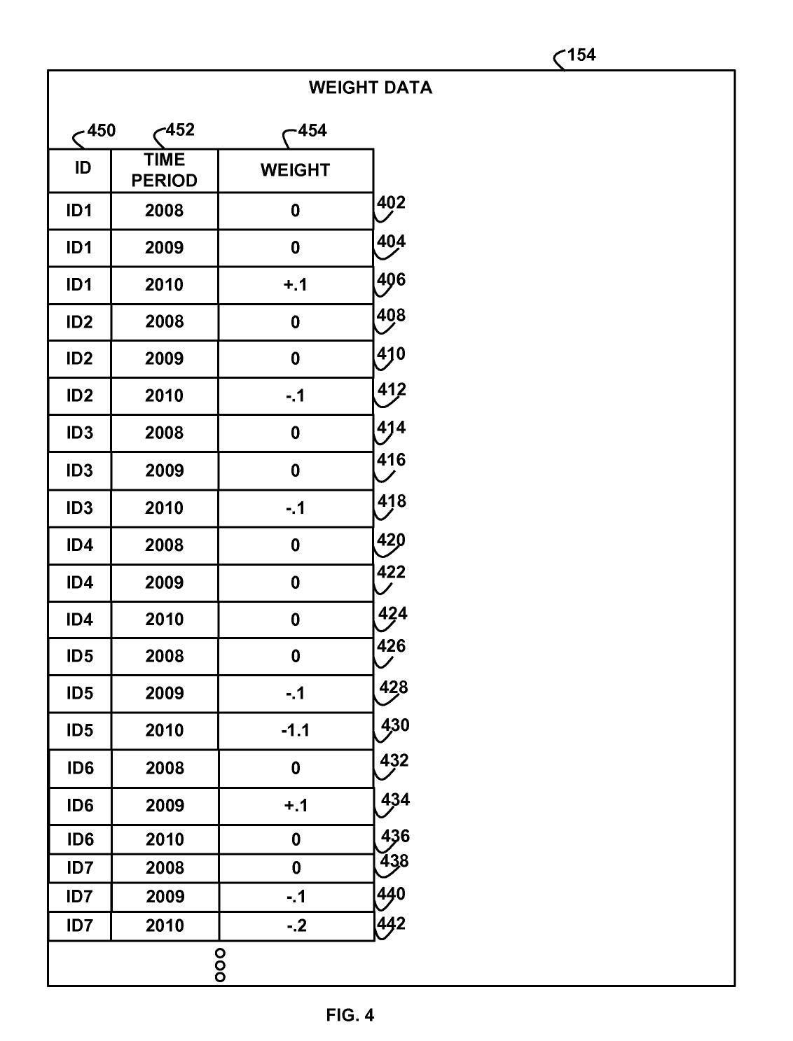

FIG. 4 depicts a block diagram of an example data structure for weight data 154, according to an embodiment of the invention. The weight data 154 comprises example records 402, 404, 406, 408, 410, 412, 414, 416, 418, 420, 422, 424, 426, 428, 430, 432, 434, 436, 438, 440, and 442, each comprising an example identifier field 450, an example time period field 452, and an example weight field 454. The identifiers 450 identify statements in the document 150 and in the topic data 152. The weight 454 specifies a weight assigned to the statement identified by the identifier 450 in the same record during the respective time period in the same record. The same statements may have the same or different weights in different time periods. In an embodiment, the weight 454 characterizes an assessment by the controller 158 of the reliability of the statement (identified by the identifier 450 in the same record). In another embodiment, the weight 454 specifies a probability that the statement (identified in the same record) is true. The controller 158 sets the weights 454 and uses the weights 454 to calculate the weighted prevalence data for different time periods, as further described below.

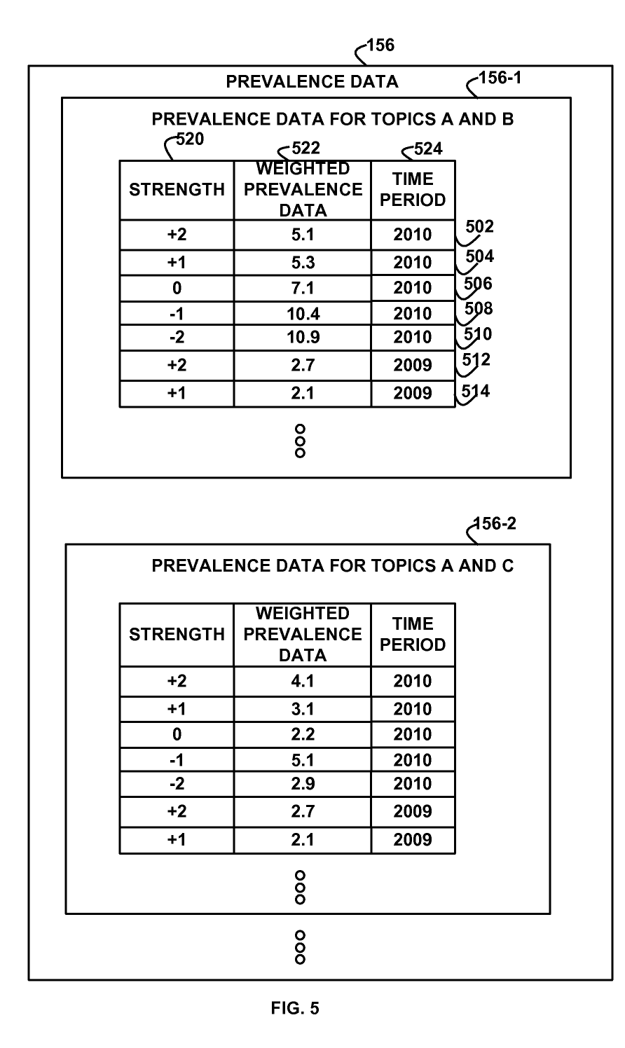

FIG. 5 depicts a block diagram of an example data structure for prevalence data 156, according to an embodiment of the invention. The prevalence data 156 comprises example prevalence data 156-1 and 156-2, and the prevalence data 156 generically refers to the prevalence data 156-1 and 156-2. The prevalence data 156-1 and 156-2 are for different combinations of topics, and each combination of topics may have its own prevalence data, which may be different from each other.

The prevalence data for topics A and B 156-1 comprises records 502, 504, 506, 508, 510, 512, and 514, each comprising an example strength field 520, an example weighted prevalence field 522, and an example time period field 524. The weighted prevalence 522 specifies the weighted number of statements (comprising the topics A and B) in the documents 150 that have or are assigned the corresponding strength 520 during the corresponding time period 524, in the same record. The time period 524 specifies an amount or a span of time. In an embodiment, the time period 524 specifies a beginning date and an ending date that delineate the time period. In various embodiments, the dates may comprise centuries, decades, years, months, days, days of the week, hours, minutes, seconds, or any multiple, portion, and/or combination thereof.

For example, the record 502 specifies a strength 520 of “+2,” weighted prevalence data 522 of “5.1” and a time period 524 of “2010,” which indicates that the topic data 152 comprises a (weighted) number of records of “5.1” (the weighted prevalence 522) that have “A” and “B” in the first topic 322 and the second topic 326 that have a strength 328 of “+2” and that have a date added 330 value of “2010” or later. The weighted prevalence 522 may specify a non-integer number of records in the topic data 152 because the controller 158 adjusts the number of records via the weight data 154, as further described below.

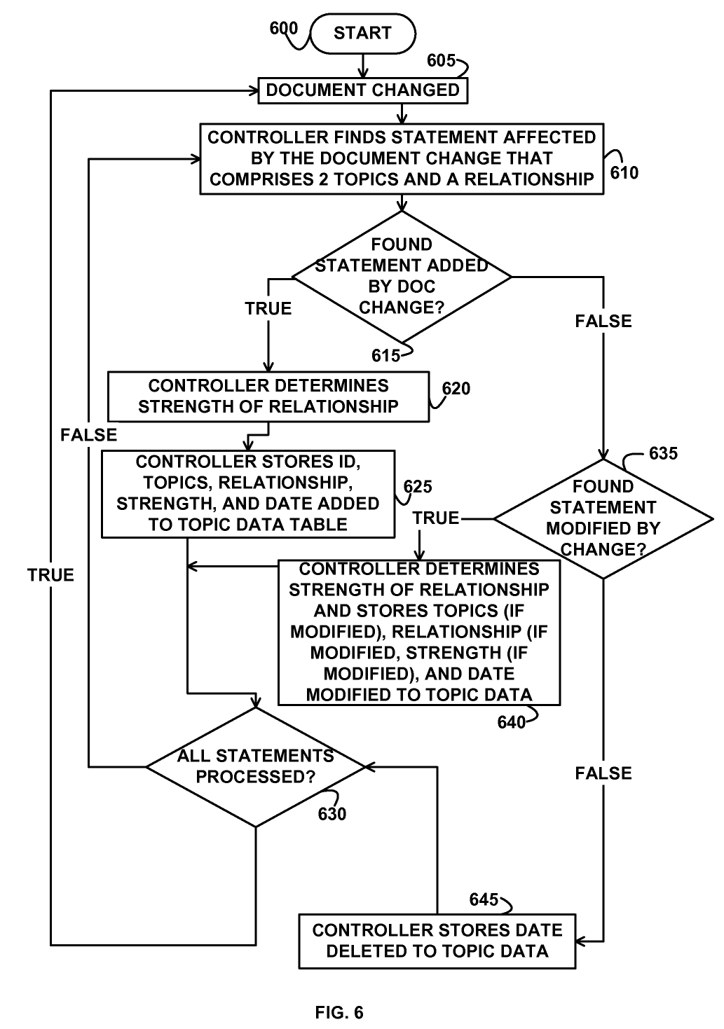

FIG. 6 depicts a flowchart of example processing for creating topic data, according to an embodiment of the invention. Control begins at block 600. Control then continues to block 605 where the controller 158 determines that the document 150 has been changed. In an embodiment, a user requests changing of the document 150 via the user I/O device 121, which sends commands and data to the controller 158 or a word processor, which updates the document 150. In another embodiment, a program executing on the processor 101 changes the document 150 or the controller 158 receives a command and optional data from the client computer 132 via the network 130.

Control then continues to block 610 where the controller 158 finds a statement affected by the change to the document 150 that comprises two topics and a relationship. In an embodiment, the controller 158 determines the topics and the relationship of the found statement via the UIMA framework. In other embodiments, the controller 158 may use the techniques of Natural Language Processing (NLP), computational linguistics, speech tagging, discourse analysis, co-reference resolution, morphological segmentation, Named Entity Recognition (NER), Optical Character Recognition (OCR), grammatical parsing of a parse tree, relationship extraction, speech recognition, speech segmentation, topic segmentation and recognition, or any combination thereof.

Control then continues to block 615 where the controller 158 determines whether the found statement was added to the document 150 by the change to the document 150. If the determination at block 615 is true, then the found statement was added by the change to the document 150, so control continues to block 620 where the controller 158 determines the strength of the relationship. In various embodiments, the controller 158 determines the strength of the relationship via the UIMA framework or any other appropriate natural language processing technique. Control then continues to block 625 where the controller 158 stores an identifier of the found statement, the topics of the found statement, the relationship of the topics in the found statement, the strength of the relationship, and the date that the statement was added to the document 150 into a new record in the topic data 152. Control then continues to block 630 where the controller 158 determines whether all statements have been processed by the loop that starts at block 610. If the determination at block 630 is true, then all statements in the changed document 150 have been processed by the loop that starts at block 610, so control returns to block 605 where the controller 158 determines that another change has been made to the same or a different document 150 by the same or a different author, as previously described above. If the determination at block 630 is false, then not all statements in the changed document 150 have been processed by the loop that starts at block 610, so control returns to block 610 where the controller 158 finds another statement affected by the change to the document 150, as previously described above.

If the determination at block 615 is false, then the found statement was not added by the change to the document 150, so control continues to block 635 where the controller 158 determines whether the found statement was modified by the change to the document 150. If the determination at block 635 is true, then the found statement was modified by the change to the document 150, so control continues to block 640 where the controller 158 determines the strength of the relationship and stores the first topic and the second topic (if modified), the relationship (if modified), the strength of the relationship (if modified), and the date that the statement was modified to the record in the topic data 152 that comprises an identifier 320 that matches the identifier of the found statement. Control then continues to block 630, as previously described above.

If the determination at block 635 is false, then the found statement was deleted by the change to the document 150, so control continues to block 645 where the controller 158 stores the date that the found statement was deleted to the record in the topic data 152 that comprises an identifier 320 that matches the identifier of the found statement. Control then continues to block 630, as previously described above.

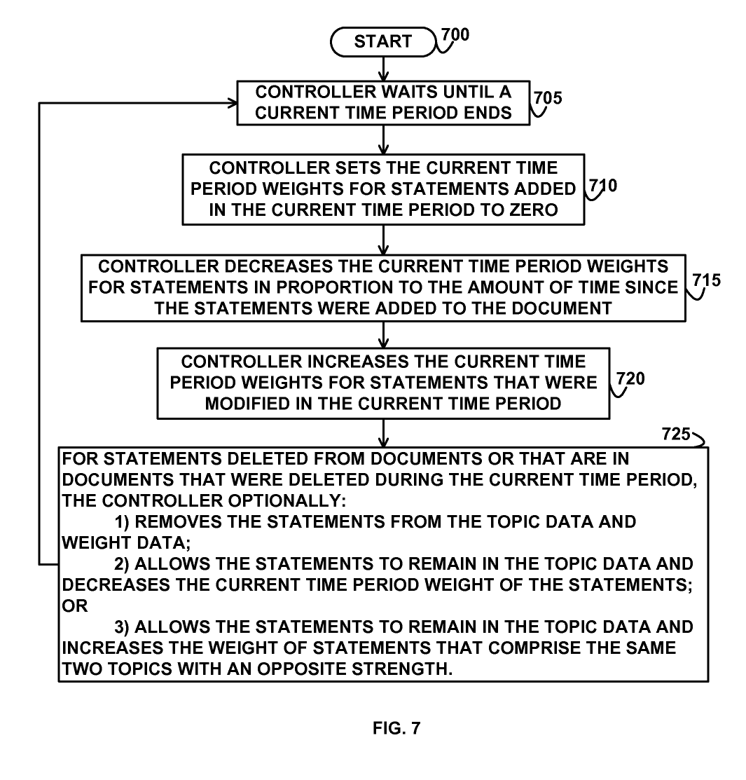

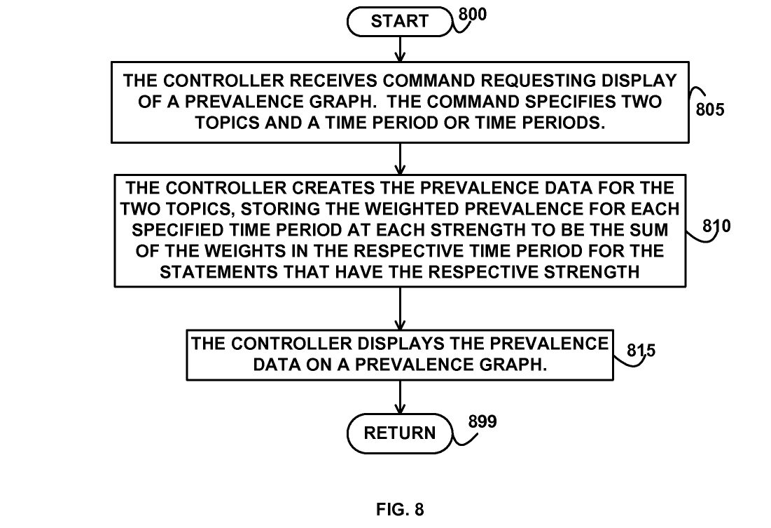

FIG. 7 depicts a flowchart of example processing for updating weight data and topic data, according to an embodiment of the invention. In an embodiment, the logic of FIG. 7 is executed concurrently, substantially concurrently, or interleaved on the same or a different processor, as the logic of FIGS. 6 and 8. Control begins at block 700.

Control then continues to block 705 where the controller 158 determines that a current time period has ended. Control then continues to block 710 where the controller 158 sets the current time period weights for statements that were added to the documents 150 during the current time period to zero. That is, the controller 158 finds the identifiers 320 in the records in the topic data 152 that comprise dates in the date added field 330 that are after the beginning of the current time period and before the end of the current time period. The controller 158 then stores new records to the weight data 154 that comprise the identifiers that were found in the topic data 152, a specification of the current time period, and a weight of zero. For any previous time periods, the controller 158 further stores new records to the weight data 154 that specify the found identifiers, a specification of any previous time periods, and a weight of zero. Thus, newly added statements have an initial weight of zero for the time period in which they were added to their document 150 and for any time periods previous to the time period in which they were added to their document 150.

Control then continues to block 715 where the controller 158 decreases the current time period weights for statements in proportion to the amount of time since the statements were added to the document 150. That is, the controller 158 finds the records in the weight data 154 with a time period field 452 that specifies a time period that matches the current time period. For each found record in the weight data 154 with a time period field 452 that matches the current time period, the controller 158 finds the corresponding record in the topic data 152 with an identifier 320 that matches the identifier 450 in the found weight data record. The controller 158 reads the date added field 330 in the corresponding record in the topic data 152 (with an identifier 320 that matches the identifier 450 in the found weight data record) and decreases the weight 454 in proportion to the amount of elapsed time from the date added 330 to the end of the current time period. Decreasing the weight 454 in proportion to the amount of elapsed time since the statement was added to the document 150 means that as a statement ages (the elapsed time since the statement was added increases) the weight 454 for that statement decreases, reflecting the weighting assessment strategy of the controller 158, which is that, all other factors being equal, older statements are less reliable or are less likely to be true or accurate than newer (added more recently) statements.

Control then continues to block 720 where the controller 158 increases the current time period weights for statements that were modified in the current time period. That is, the controller 158 finds the records in the weight data 154 with a time period field 452 that specifies a time period that matches the current time period. For each found record in the weight data 154 with a time period field 452 that matches the current time period, the controller 158 finds the corresponding record in the topic data 152 with an identifier 320 that matches the identifier 450 in the found weight data record. The controller 158 reads the date modified field 332 in the corresponding record in the topic data 152 (with an identifier 320 that matches the identifier 450 in the found weight data record). If the contents of the date modified field 332 are within the current time period (after the beginning of the current time period and before the end of the current time period), then the controller 158 increases the weight 454. In various embodiments, the amount that the controller 158 increases the weight 454 is set by a designer of the controller 158, is submitted by a user or computer system administrator via the user I/O device 121, is received by the controller 158 from an application executing in the computer system 100, or is received by the controller 158 from the client computer 132 via the network 130. If the contents of the date modified field 332 are not within the current time period (is before the beginning of the current time period or after the end of the current time period), then controller 158 does not increase the weight 454. Increasing the weight 454 for a statement that has been modified reflects the weighting assessment strategy of the controller 158 that, all other factors being equal, a statement that has been modified is more reliable or more likely to be true or accurate than an unmodified statement.

Control then continues to block 725 where, for statements deleted from documents 150 or that are in the documents 150 that were deleted during the current time period, the controller 158 optionally: 1) removes the statements from the topic data 152 and weight data 154; 2) allows the statements to remain in the topic data 152 and decreases the current time period weight (the weight for the current time period in which the statements were deleted) of the statements; or 3) allows the statements to remain in the topic data 152 and increases the weight of statements that comprise the same two topics with an opposite strength from the deleted statements. Thus, the controller 158 increases the weights for a first subset of the statements that have opposite strengths to the strengths of a second subset of the statements that were deleted. In an embodiment, opposite strengths have different signs but the same absolute values. Control then returns to block 705 where the controller 158 waits for the next current time period to end, as previously described above. The processing of block 725 reflects the weighting assessment strategy of the controller 158 that, all other factors being equal, a statement that has been deleted from the documents 150 is less reliable or less likely to be true or accurate than a statement that remains in the documents 150.

FIG. 8 depicts a flowchart of example processing for creating prevalence data, according to an embodiment of the invention. Control begins at block 800. Control then continues to block 805 where the controller 158 receives a command requesting display of a prevalence graph 200. The command specifies two topics and a time period or time periods. Control then continues to block 810 where, in response to the command, the controller 158 creates the prevalence data for the two topics, storing the weighted prevalence 522 for each specified time period at each strength 520 to be the sum of the weights 454 for the statements in the respective time period that have the respective strength. Control then continues to block 815 where, in response to the command, the controller 158 displays or plots the prevalence data 156 on a prevalence graph 200. Control then continues to block 899 where the logic of FIG. 8 returns.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure embodiments of the invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense.

What is claimed is:

1. A method comprising:
determining respective strengths for a plurality of respective relationships in a plurality of respective statements;
decreasing weights for the plurality of respective statements in proportion to respective amounts of time since the plurality of respective statements were added;
increasing the weights for the plurality of statements that were modified;
calculating a plurality of weighted prevalence data in a plurality of respective time periods for the plurality of respective statements to be a sum of the weights for the plurality of respective statements in the plurality of respective time periods that have the respective strengths; and
displaying the plurality of weighted prevalence data at each of the plurality of respective time periods for each of the respective strengths.

2. The method of claim 1, wherein the displaying further comprises:
displaying the plurality of weighted prevalence data for two topics at each of the plurality of respective time periods for each of the respective strengths, wherein each of the plurality of respective statements comprise the plurality of respective relationships of the two topics.

3. The method of claim 2, further comprising:
performing the displaying in response to a command that specifies the two topics and the plurality of respective time periods.

4. The method of claim 2, wherein if a first statement is true and the first statement comprises the two topics with a first strength, then a second statement that comprises the two topics with a second strength that is opposite the first strength is false.

5. The method of claim 2, wherein if a third statement is false and the third statement comprises the two topics with a third strength, then a fourth statement that comprises the two topics with a fourth strength that is opposite the third strength is true.

6. The method of claim 1, further comprising:
decreasing the weights for the plurality of statements that were deleted.

7. The method of claim 1, further comprising:
increasing the weights for a first subset of the plurality of respective statements that have opposite strengths to the respective strengths of a second subset of the plurality of statements that were deleted.

8. A computer-readable storage medium encoded with instructions, wherein the instructions when executed comprise:
determining respective strengths for a plurality of respective relationships in a plurality of respective statements;
decreasing weights for the plurality of respective statements in proportion to respective amounts of time since the plurality of respective statements were added;
increasing the weights for the plurality of statements that were modified;
calculating a plurality of weighted prevalence data in a plurality of respective time periods for the plurality of respective statements to be a sum of the weights for the plurality of respective statements in the plurality of respective time periods that have the respective strengths; and
displaying the plurality of weighted prevalence data at each of the plurality of respective time periods for each of the respective strengths.

9. The computer-readable storage medium of claim 8, wherein the displaying further comprises:
displaying the plurality of weighted prevalence data for two topics at each of the plurality of respective time periods for each of the respective strengths, wherein each of the plurality of respective statements comprise the plurality of respective relationships of the two topics.

10. The computer-readable storage medium of claim 9, further comprising:
performing the displaying in response to a command that specifies the two topics and the plurality of respective time periods.

11. The computer-readable storage medium of claim 9, wherein if a first statement is true and the first statement comprises the two topics with a first strength, then a second statement that comprises the two topics with a second strength that is opposite the first strength is false.

12. The computer-readable storage medium of claim 9, wherein if a third statement is false and the third statement comprises the two topics with a third strength, then a fourth statement that comprises the two topics with a fourth strength that is opposite the third strength is true.

13. The computer-readable storage medium of claim 8, further comprising:
decreasing the weights for the plurality of statements that were deleted.

14. The computer-readable storage medium of claim 8, further comprising:
increasing the weights for a first subset of the plurality of respective statements that have opposite strengths to the respective strengths of a second subset of the plurality of statements that were deleted.

15. A computer comprising:
a processor; and
memory communicatively coupled to the processor, wherein the memory is encoded with instructions, wherein the instructions when executed on the processor comprise
determining respective strengths for a plurality of respective relationships in a plurality of respective statements,
decreasing weights for the plurality of respective statements in proportion to respective amounts of time since the plurality of respective statements were added,
increasing the weights for the plurality of statements that were modified,
calculating a plurality of weighted prevalence data in a plurality of respective time periods for the plurality of respective statements to be a sum of the weights for the plurality of respective statements in the plurality of respective time periods that have the respective strengths, and
displaying the plurality of weighted prevalence data at each of the plurality of respective time periods for each of the respective strengths, wherein the displaying further comprises displaying the plurality of weighted prevalence data for two topics at each of the plurality of respective time periods for each of the respective strengths, wherein each of the plurality of respective statements comprise the plurality of respective relationships of the two topics.

16. The computer of claim 15, wherein the instructions further comprise:
performing the displaying in response to a command that specifies the two topics and the plurality of respective time periods.

17. The computer of claim 15, wherein if a first statement is true and the first statement comprises the two topics with a first strength, then a second statement that comprises the two topics with a second strength that is opposite the first strength is false.

18. The computer of claim 15, wherein if a third statement is false and the third statement comprises the two topics with a third strength, then a fourth statement that comprises the two topics with a fourth strength that is opposite the third strength is true.

19. The computer of claim 15, wherein the instructions further comprise:
decreasing the weights for the plurality of statements that were deleted.

20. The computer of claim 15, wherein the instructions further comprise:
increasing the weights for a first subset of the plurality of respective statements that have opposite strengths to the respective strengths of a second subset of the plurality of statements that were deleted.
